(19) United States
(12) Patent Application Publication
(10) Pub. No.: US 2026/0052504 A1
(43) Pub. Date: Feb. 19, 2026

(54) Methods for Sidelink Positioning Measurements

(71) Applicant: Apple Inc., Cupertino, CA (US)

(72) Inventors: Oghenekome Oteri, San Diego, CA (US); Chunxuan Ye, San Diego, CA (US); Seyed Ali Akbar Fakoorian, San Diego, CA (US); Wei Zeng, Saratoga, CA (US); Weidong Yang, San Diego, CA (US); Chunhai Yao, Beijing (CN); Dawei Zhang, Saratoga, CA (US); Sigen Ye, San Diego, CA (US); Hong He, San Jose, CA (US)

(21) Appl. No.: 19/101,206

(22) PCT Filed: Aug. 12, 2022
(86) PCT No.: PCT/CN2022/112082

§ 371 Date: Feb. 4, 2025

(51) Int. Cl. H04W 64/00; H04W 72/25

(52) U.S. Cl. CPC H04W 64/00; H04W 72/25

(57) ABSTRACT

Apparatuses, systems, and methods for Sidelink positioning in 5G Advanced, e.g., in 5G NR systems and beyond. A UE may determine a synchronization reference UE for performance of sidelink positioning measurements. Additionally, the UE may determine a positioning reference UE for performance of the sidelink positioning measurements. Further, the UE may perform sidelink positioning measurements, e.g., while synchronization to the synchronization reference UE and/or while using the positioning reference UE to aid in determining a location of the UE. The positioning reference UE may always be the synchronization reference UE and the synchronization UE may not always be the positioning reference UE. In some instances, the positioning reference UE and the synchronization reference UE may be the same UE or the positioning reference UE and the synchronization reference UE may be different UEs.

### FIELD

The invention relates to wireless communications, and more particularly to apparatuses, systems, and methods for sidelink positioning in 5G Advanced, e.g., in 5G NR systems and beyond.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

### SUMMARY

Embodiments relate to wireless communications, and more particularly to apparatuses, systems, and methods for sidelink positioning in 5G Advanced, e.g., in 5G NR systems and beyond.

For example, in some embodiments, a UE may be configured to receive a stage 1 sidelink control information (SCI) and identify, based on decoding the stage 1 SCI, that a resource is within one or more of a resource pool for a physical sidelink shared channel (PSSCH) or a resource pool for sidelink reference signal (RS). The sidelink RS may be one of a positioning reference signal (PRS) or sounding reference signal (SRS). In addition, the UE may be configured to identify, based on decoding a stage 2 SCI, a bit indicating addressing for PSSCH and sidelink RS. The stage 2 SCI may be one of an SCI Format 0, SCI Format 1, or SCI Format 2. The stage 2 SCI may include one or more of a hybrid automatic repeat request (HARQ) identifier (ID), a new data indicator, a redundancy version, a source ID, and/or a destination ID.

As another example, in some embodiments, a UE may be configured to receive an SCI that may include a stage 1 SCI and/or a stage 2 SCI. The UE may be configured to identify, based on decoding the stage 1 SCI and the stage 2 SCI, that a resource is within one or more of a resource pool for a PSSCH or a resource pool for a sidelink RS. Further, the UE may be configured to determine, based on a group identifier in the stage 2 SCI, whether the UE is receiving or not receiving one or more of the PSSCH or sidelink RS.

As a further example, in some embodiments, a UE may be configured to receive an SCI that may include a stage 1 SCI and/or a stage 2 SCI. The UE may be configured to identify, based on decoding the stage 1 SCI and the stage 2 SCI, that a resource is within one or more of a resource pool for a PSSCH or a resource pool for a sidelink RS. Further, the UE may be configured to, in response to determining, based at least in part, on the stage 2 SCI, the UE is receiving the sidelink RS, perform positioning reporting, e.g., based on a measurement indicator included in the stage 2 SCI.

As an additional example, in some embodiments, a UE may be configured to determine a synchronization reference UE for performance of sidelink positioning measurements. Additionally, the UE may be configured to determine a positioning reference UE for performance of the sidelink positioning measurements. Further, the UE may be configured to perform sidelink positioning measurements, e.g., while synchronization to the synchronization reference UE and/or while using the positioning reference UE to aid in determining a location of the UE. The positioning reference UE may always be the synchronization reference UE and the synchronization UE may not always be the positioning reference UE. In some instances, the positioning reference UE and the synchronization reference UE may be the same UE or the positioning reference UE and the synchronization reference UE may be different UEs.

As a yet further example, in some embodiments, a UE may be configured to receive an SCI that may include a stage 1 SCI and/or a stage 2 SCI. The UE may be configured to identify, based on decoding the stage 1 SCI and the stage 2 SCI, that a resource is within one or more of a resource pool for a PSSCH or a resource pool for a sidelink RS. In addition, the UE may be configured to determine a resource allocation for one or more of the PSSCH or sidelink RS. In some instances, the UE may sense resources for one or more of the PSSCH or sidelink RS. In some instances, the PSSCH and the sidelink RS may use a common resource allocation or may have different resource allocations.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system according to some embodiments.

FIG. 2 illustrates an example block diagram of a base station, according to some embodiments.

FIG. 3 illustrates an example block diagram of a server, according to some embodiments.

FIG. 4 illustrates an example block diagram of a UE, according to some embodiments.

FIG. 5 illustrates an example of a 5G network architecture that incorporates both dual 3GPP (e.g., LTE and 5G NR) access and non-3GPP access to the 5G CN, according to some embodiments.

FIG. 6 illustrates an example of a unicast transmission of a sidelink RS and PSCCH, according to some embodiments.

FIG. 7 illustrates an example of a multicast transmission of a sidelink RS and PSCCH, according to some embodiments.

FIG. 8 illustrates an example of a broadcast transmission of a sidelink RS and PSCCH, according to some embodiments.

FIG. 9 illustrates an example of using an SCI for a PSSCH and a sidelink RS, according to some embodiments.

FIG. 10 illustrates an example of UE grouping for receiving multicast PSSCH and sidelink RSs, according to some embodiments.

FIG. 11 illustrates an example of UE grouping for receiving broadcast PSSCH and sidelink RSs, according to some embodiments.

FIG. 12 illustrates an example of using dedicated SCIs for PSSCH and sidelink RS, according to some embodiments.

FIG. 13 illustrates an example of using a different stage 2 SCI for PSSCH and sidelink RS, according to some embodiments.

FIG. 14A illustrates an example of using destination IDs for the PSSCH and sidelink RS, according to some embodiments.

FIG. 14B illustrates an example of using one destination ID for both the PSSCH and sidelink RS, according to some embodiments.

FIG. 14C illustrates an example of using individual destination IDs associated with the PSSCH and the sidelink RS, according to some embodiments.

FIG. 15 illustrates a block diagram of an example of a method for signaling PSSCH and sidelink RSs, according to some embodiments.

FIG. 16 illustrates a block diagram of another example of a method for signaling PSSCH and RSs, according to some embodiments.

FIG. 17 illustrates a block diagram of an example of a method for positioning reporting, according to some embodiments.

FIG. 18 illustrates a block diagram of an example of a method for performing sidelink positioning measurements, according to some embodiments.

FIG. 19 illustrates a block diagram of another example of a method for determining resource allocation for a physical sidelink shared channel (PSSCH) and/or a sidelink reference signals (RSs), according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
BS: Base Station
DL: Downlink
UL: Uplink
LTE: Long Term Evolution
NR: New Radio
5GS: 5G System
5GMM: 5GS Mobility Management
5GC/5GCN: 5G Core Network
SIM: Subscriber Identity Module
eSIM: Embedded Subscriber Identity Module
IE: Information Element
CE: Control Element
MAC: Medium Access Control
SSB: Synchronization Signal Block
PDCCH: Physical Downlink Control Channel
PDSCH: Physical Downlink Shared Channel
RRC: Radio Resource Control

### Terms

The following is a glossary of terms used in this disclosure:
Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.
Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.
User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAS, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.
Base Station—The term “Base Station” has the full breadth of its ordinary meaning, and at least includes a wireless communication station installed at a fixed location and used to communicate as part of a wireless telephone system or radio system.
Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.
Band—The term “band” has the full breadth of its ordinary meaning, and at least includes a section of spectrum (e.g., radio frequency spectrum) in which channels are used or set aside for the same purpose.
Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.
3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.
Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.
Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.
Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.
Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to”may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S. C. § 112(f) interpretation for that component.

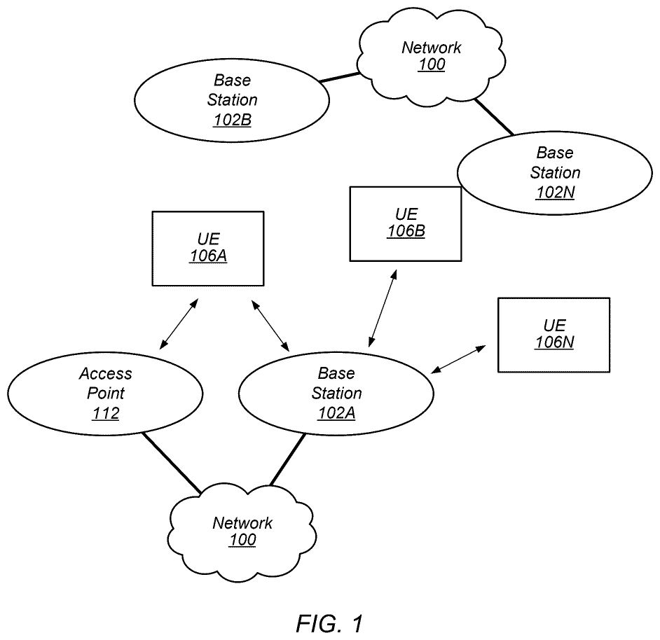

### FIG. 1: Communication Systems

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B. 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

In addition, the UE 106 may be in communication with an access point 112, e.g., using a wireless networking (e.g., Wi-Fi) and/or peer-to-peer wireless communication protocol (e.g., Bluetooth, Wi-Fi peer-to-peer, etc.). The access point 112 may provide a connection to the network 100.

Note that a UE 106 may be capable of communicating using multiple wireless communication standards. Thus, the UE 106 may be a device with both cellular communication capability and non-cellular communication capability (e.g., Bluetooth, Wi-Fi, and so forth) such as a mobile phone, a hand-held device, a computer or a tablet, or virtually any type of wireless device. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

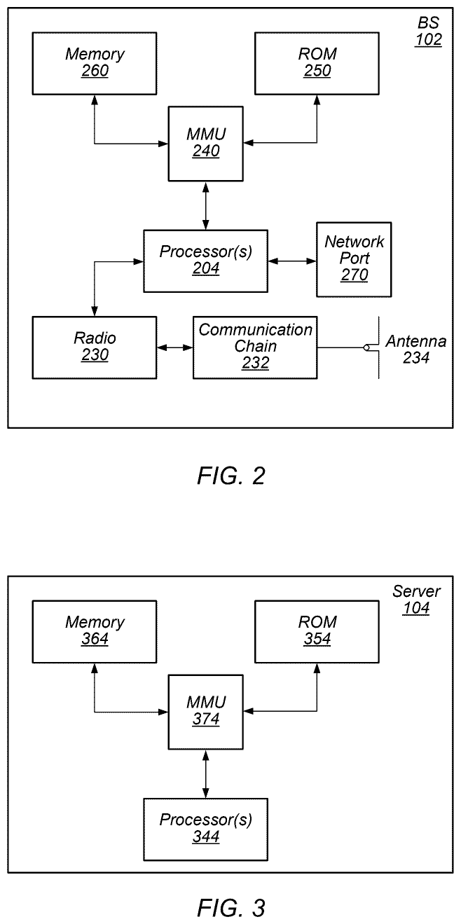

### FIG. 2: Block Diagram of a Base Station

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (Ics) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (Ics) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (Ics) that are configured to perform the functions of processor(s) 344. In addition, each integrated circuit may include circuitry (e.g., first circuitry, second circuitry, etc.) configured to perform the functions of processor(s) 344.

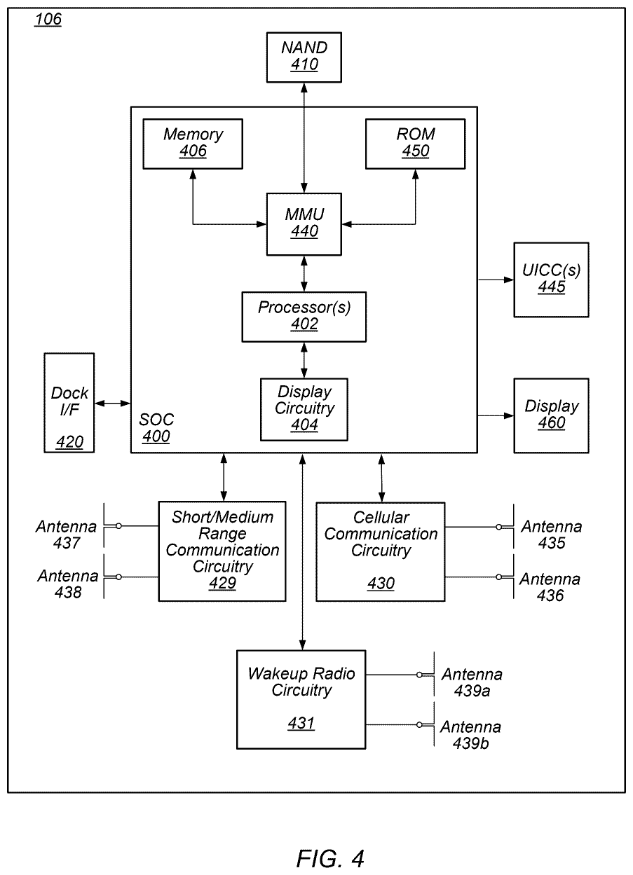

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., short to medium range wireless communication circuitry 429 (e.g., Bluetooth™ and WLAN circuitry), and wakeup radio circuitry 431. In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The wakeup radio circuitry 431 may also couple (e.g., communicatively; directly or indirectly) to one or more antennas, such as antennas 439a and 439b as shown. Alternatively, the wakeup radio circuitry 431 may couple (e.g., communicatively; directly or indirectly) to the antennas 435 and 436 in addition to, or instead of, coupling (e.g., communicatively; directly or indirectly) to the antennas 439a and 439b. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration. The wakeup radio circuitry 431 may include a wakeup receiver, e.g., wakeup radio circuitry 431 may be a wakeup receiver. In some instances, wakeup radio circuitry 431 may be a low power and/or ultra-low power wakeup receiver. In some instances, wakeup radio circuitry may only be powered/active when cellular communication circuitry 430 and/or the short to medium range wireless communication circuitry 429 are in a sleep/no power/inactive state. In some instances, wakeup radio circuitry 431 may monitor (e.g., periodically) a specific frequency/channel for a wakeup signal. Receipt of the wakeup signal may trigger the wakeup radio circuitry 431 to notify (e.g., directly and/or indirectly) cellular communication circuitry 430 to enter a powered/active state.

In some embodiments, as further described below, cellular communication circuitry 430 may include dedicated receive chains (including and/or coupled to, e.g., communicatively; directly or indirectly, dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VOLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for revocation and/or modification of user consent in MEC, e.g., in 5G NR systems and beyond, as further described herein. For example, the communication device 106 may be configured to perform methods for CORESET #0 configuration, SSB/CORESET #0 multiplexing pattern 1 for mixed SCS, time-domain ROs determination for 480 kHz/960 kHz SCSs, and RA-RNTI determination for 480 kHz/960 kHz SCSs.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (Ics) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (Ics) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more Ics that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

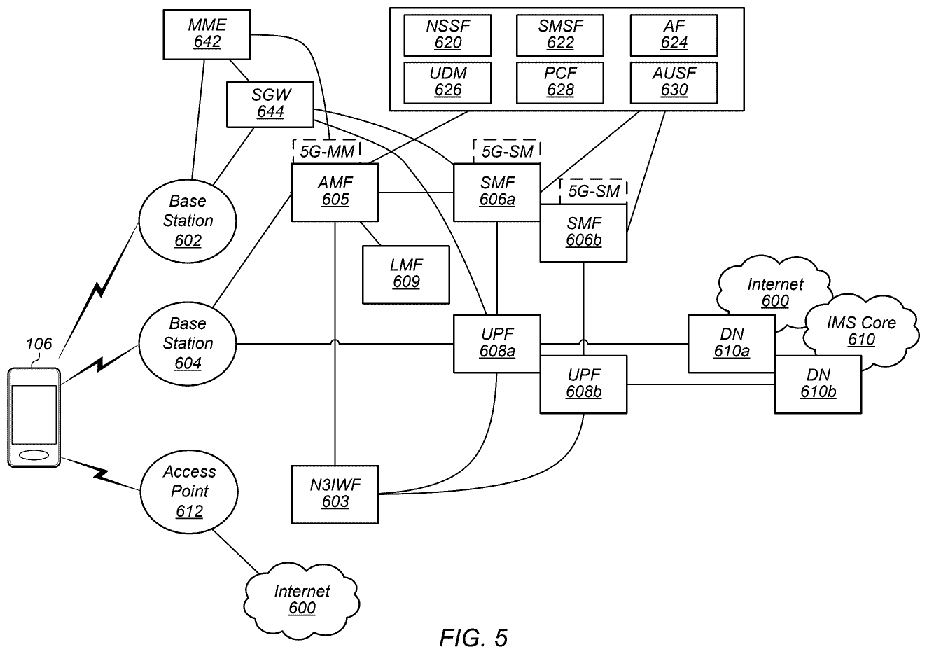

### FIGS. 5: 5G Core Network Architecture-Interworking With Wi-Fi

In some embodiments, the 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 5 illustrates an example of a 5G network architecture that incorporates both dual 3GPP (e.g., cellular access via LTE and 5G-NR) and non-3GPP (e.g., non-cellular) access to the 5G CN, according to some embodiments. As shown, a user equipment device (e.g., such as UE 106) may access the 5G CN through both a radio access network (RAN, e.g., such as gNB 604 or eNB 602, which may each be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. In addition, the 5G CN may support dual-registration of the UE on both a legacy network (e.g., LTE via eNB 602) and a 5G network (e.g., via gNB 604). As shown, the eNB 602 may have connections to a mobility management entity (MME) 642 and a serving gateway (SGW) 644. The MME 642 may have connections to both the SGW 644 and the AMF 605. In addition, the SGW 644 may have connections to both the SMF 606a and the UPF 608a. As shown, the AMF 605 may be in communication with a location management function (LMF) 609 via a networking interface, such as an NLs interface. The LMF 609 may receive measurements and assistance information from the RAN (e.g., gNB 604) and the UE (e.g., UE 106) via the AMF 605. The LMF 609 may be a server (e.g., server 104) and/or a functional entity executing on a server. Further, based on the measurements and/or assistance information received from the RAN and the UE, the LMF may determine a location of the UE. In addition, the AMF 605 may include functional entities associated with the 5G CN (e.g., such as a network slice selection function (NSSF), a short message service function 622, an application function (AF), unified data management (UDM), a policy control function (PCF), and/or an authentication server function. Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

Note that in various embodiments, one or more of the above-described network entities may be configured to perform methods for sidelink positioning in 5G Advanced, e.g., in 5G NR systems and beyond, e.g., as further described herein.

Note that in various embodiments, one or more of the above-described functional entities of the 5G NAS and/or 5G AS may be configured to perform methods for sidelink positioning in 5G Advanced, e.g., in 5G NR systems and beyond, e.g., as further described herein.

### Sidelink Positioning in 5G Advanced

In current implementations, methods for sidelink positioning in cellular systems, e.g., such as NR cellular systems have not been defined and/or agreed upon. However, a new reference signal for sidelink positioning/ranging may be used, based on existing positioning reference signal (PRS) and sounding reference signal (SRS) designs and sidelink framework as a starting basis. In addition, for sidelink positioning allocation, various options for sidelink positioning resource configuration (or pre-configuration), such as a dedicated resource pool for a sidelink PRS and/or a resource pool shared with sidelink communications, may be used. Additionally, both network-centric operations for sidelink PRS resource allocation (e.g., similar to a legacy Mode 1 solution) and a UE autonomous sidelink PRS resource allocation (e.g., similar to legacy Mode 2 solution) may serve as options for sidelink PRS resource allocation. Further, with regards to the configuration/activation/deactivation/triggering of a sidelink PRS, various options may be available, such as high-layer-only signaling involvement in the sidelink PRS configuration, high-layer and lower-layer signaling involvement in the sidelink PRS configuration, and only lower-layer signaling involvement in the sidelink PRS configuration. Finally, the contents and time domain behavior of a measurement report may need to be defined to facilitate sidelink positioning operations.

Embodiments described herein provide systems, methods, and mechanisms for sidelink positioning in 5G Advanced, including systems, methods, mechanisms for PSSCH and sidelink RS (PRS and/or SRS) transmission to UE groups, signaling for independent PSSCH and sidelink RS targets, receiving UE measurement reporting, synchronization and sidelink SSB for sidelink positioning, and sensing and resource allocation.

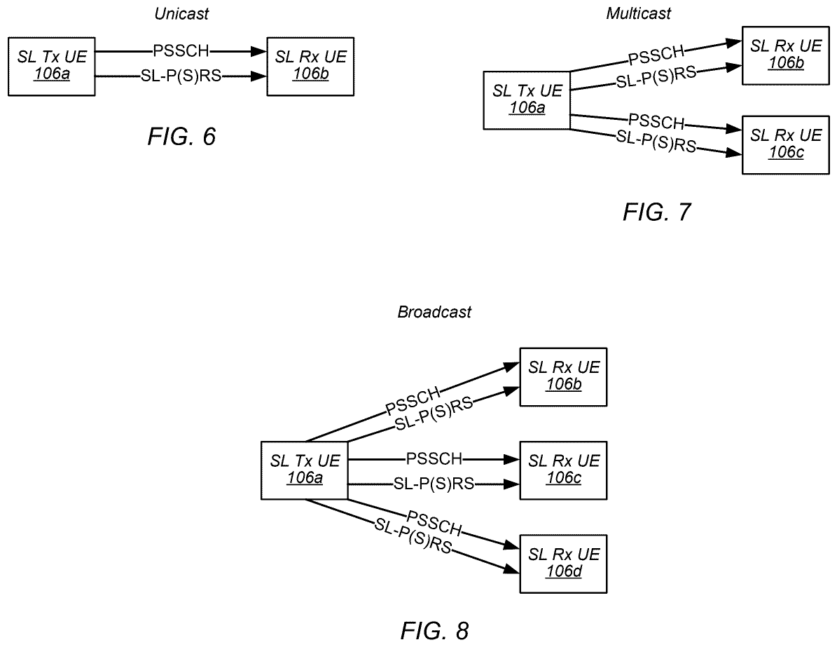

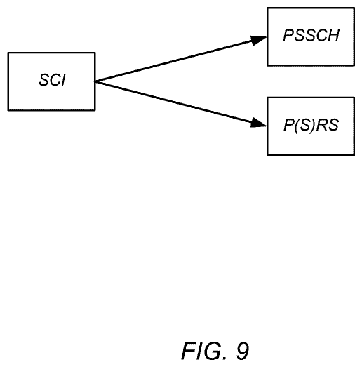

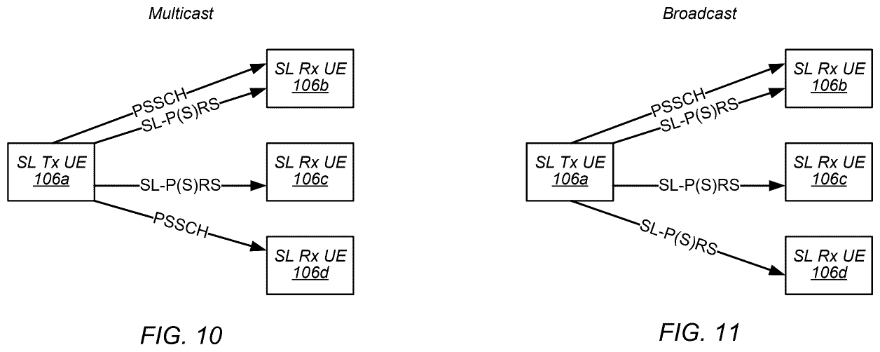

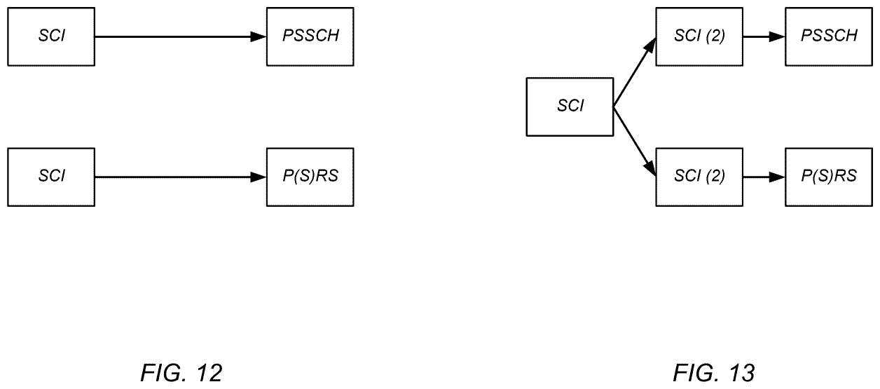

For example, in some instances, a stage 1 sidelink control information (SCI, e.g., SCI stage 1) may include a priority, time resource assignment, a frequency resource assignment, a stage 2 SCI format, a modulation and coding scheme (MCS), and/or a resource reservation period. In some instances, the stage 2 SCI may include a hybrid automatic repeat request (HARQ) process identifier (ID), a new data indicator (NDI), a redundancy version, a source ID, and/or a destination ID. The stage 2 SCI may be an SCI Format 0, an SCI Format 1, and/or an SCI Format 2. In some instances, the sidelink RS (e.g., sidelink PRS and/or sidelink SRS) may be unicast, broadcast or multi-cast, e.g., as illustrated by FIG. 6 (unicast), FIG. 7 (multicast), and FIG. 8 (broadcast). As shown in FIG. 6, a sidelink transmitter, e.g., such as SL Tx UE 106a, may send a unicast transmission of a PSSCH and a sidelink PRS or SRS (e.g., a SL-P(S)RS) to a receiving transmitter, e.g., such as SL Tx UE 106b. As shown in FIG. 7, a sidelink transmitter, e.g., such as SL Tx UE 106a, may send a multicast transmission of a PSSCH and a sidelink PRS or SRS (e.g., a SL-P(S)RS) to receiving transmitters, e.g., such as SL Tx UEs 106b and 106c. As shown in FIG. 8, a sidelink transmitter, e.g., such as SL Tx UE 106a, may send a broadcast transmission of a PSSCH and a sidelink PRS or SRS (e.g., a SL-P(S)RS) to receiving transmitters, e.g., such as SL Tx UEs 106b-d. In some instances, for a broadcast and/or multicast sidelink RS, UE grouping may be the same as a UE grouping for a physical sidelink shared channel (PSSCH). In other words, the PSSCH and the sidelink RS may be bundled together. In some instances, an SCI for the PSSCH may be reused for signaling the sidelink RS (e.g., a positioning reference signal (PRS) and/or a sounding reference signal (SRS), denoted as P(S)RS), e.g., as illustrated by FIG. 9. Note that in such instances, the sidelink RS may have the same frequency resource as the PSSCH or a different frequency resource than the PSSCH. In some instances, a frequency resource may be configured for the sidelink RS. In some instances, for a broadcast and/or multicast sidelink RS, UE grouping may be independent of a UE grouping for the PSSCH, e.g., as illustrated by FIG. 10 (multicast case) and 11 (broadcast case). In such instances, the sidelink RS may use a specific or dedicated SCI, e.g., as illustrated by FIG. 12. In such instances, e.g., such as for periodic and/or semi-persistent sidelink RS transmissions, the sidelink RS may be pre-configured. In some instances, the sidelink RS and the PSSCH may use the same stage 1 SCI and a different stage 2 SCI, e.g., as illustrated by FIG. 13. In some instances, the sidelink RS and the PSSCH may use different stage 1 and stage 2 SCIs. Note that in this case, the triggering/activating SCI may refer to a (pre-)configuration ID that has the details of the RS resource allocation.

In some instances, it may be beneficial and/or advantageous to enable signaling for independent transmission of a PSSCH and a sidelink RS (e.g., a sidelink PRS and/or a sidelink SRS) to target UEs. Thus, groups of UEs (e.g., groups of target UEs) may be assigned destination identifiers (IDs). For example, in some instances, a stage 2 SCI may carry a destination ID that may be set to a groupcast/multicast/broadcast address. The address may be 16 bits. In some instances, an extra bit in the stage 2 SCI may be used to indicate to UEs a separate grouping for the PSSCH and the sidelink RS. In other words, the stage 2 SCI may be enhanced to carry an extra bit to indicate to UEs a separate grouping for the PSSCH and the sidelink RS.

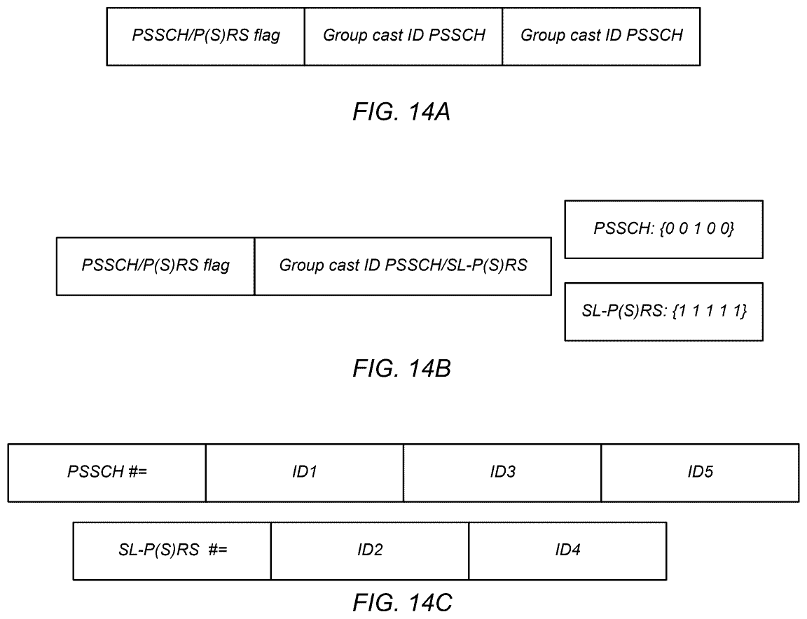

In some instances, a stage 2 SCI may carry a first destination ID associated with a first group of UEs receiving the PSSCH and a second destination ID associated with a second group of UEs receiving the sidelink RS, e.g., as illustrated by FIG. 14A. Note that the first group of UEs and the second group of UEs may not be exclusive to one another. In other words, one or more UEs may belong to (or be grouped with) both the first group of UEs and the second group of UEs. Similarly, one or more other UEs may only belong to (or be grouped with) either the first group of UEs or the second group of UEs.

In some instances, a stage 2 SCI may carry one destination ID associated with both the PSSCH and the sidelink RS. In such instances, a bitmap may be used to indicate a first subset of UEs receiving the PSSCH and a second subset of UEs receiving the sidelink RS e.g., as illustrated by FIG. 14B. Note that that the first subset of UEs and the second subset of UEs may not be exclusive to one another. In other words, one or more UEs may belong to (or be grouped with) both the first subset of UEs and the second subset of UEs. Similarly, one or more other UEs may only belong to (or be grouped with) either the first subset of UEs or the second subset of UEs. In some instances, a first bitmap may be used to indicate the first subset of UEs (e.g., UEs receiving the PSSCH) and a second bitmap may be used to indicate the second subset of UEs (e.g., UEs receiving the sidelink RS). The length of the bitmap may be and/or may be based on, a number of UEs in a groupcast/multicast. In some instances, a UE assignment to a position in the bitmap may be indicated in a configuration, e.g., via higher layer signaling such as RRC signaling or a MAC control element. In some instances, a bitmap may be used to indicate a specific set of UEs. In some instances, all UEs may be assumed to receive the sidelink RS and a bitmap may be used to indicate a group of UEs to receive the PSSCH. The length of the bitmap may be and/or may be based on, a number of UEs in a groupcast/multicast. In some instances, a UE assignment to a position in the bitmap may be indicated in a configuration, e.g., via higher layer signaling such as RRC signaling or a MAC control element. In some instances, all UEs may be assumed to receive the PSSCH and a bitmap may be used to indicate a group of UEs to receive the sidelink RS. The length of the bitmap may be and/or may be based on, a number of UEs in a groupcast/multicast. In some instances, a UE assignment to a position in the bitmap may be indicated in a configuration, e.g., via higher layer signaling such as RRC signaling or a MAC control element. In some instances, a maximum bitmap size may be fixed. In some instances, e.g., for overhead management, if UEs exhibit a maximum bitmap multiple to 1, then modulo a maximum group size.

In some instances, a stage 2 SCI may indicate individual destination IDs associated with the PSSCH and the sidelink RS, e.g., as illustrated by FIG. 14C. For example, a number and destination ID may be indicated for receipt of the PSSCH. Similarly, a number and destination ID may be indicated for receipt of the sidelink RS. In some instances, a number and destination ID for receipt of both the PSSCH and sidelink RS may also be indicated. Note that individual destination IDs may be 16 bit IDs and/or may be configured and/or dynamically assigned IDs of a specified number of bits.

In some instances, measurement reporting may be indicated in a stage 2 SCI, may be preconfigured, and/or may be based on an LTE positioning protocol (LLP procedure). For example, in some instances, a stage 2 SCI may include a measurement indicator to indicate to a UE that positioning measurement reporting is required, e.g., for aperiodic feedback. Note that a trigger may indicate that feedback may be sent. As another example, in some instances, the measurement reporting may be configured and/or preconfigured, e.g., for periodic or semi-persistent transmission. As further example, in some instances, measurement reporting may be based on the LLP procedure, e.g., only send to a location management function (LMF) (e.g., an entity in a core network or UE group that performed positioning estimation). This may effectively be higher layer signaling.

In some instances, a type of measurement to be performed and reported may be preconfigured. Note that types of measurement may include sidelink time difference of arrival (SL-TdoA) and/or sideling RS (e.g., sidelink PRS and/or sidelink SRS) reference signal received power (RSRP). In some instances, the type of measurement may be indicated by a MAC control element over a PSSCH sent from one UE to another UE. In some instances, the type of measurement may be indicated to a base station via PUSSCH or PUSCH. In some instances, the type of measurement may be indicated by higher layer signaling, for example, to an LMF (an/or sidelink or local LMF) via LLP. The time domain behaviour of the measurement report may be one of (a) aperiodic one-shot feedback where the feedback is at a specific timing after a positioning action in the positioning procedure (e.g., for RTT based positioning, the feedback resource is indicated during the RTT reference signal set up at a specific resource after the last reference signal is transmitted), (b) aperiodic or semi-persistent triggered feedback, where the feedback (either higher layer or lower layer) may occur based on receipt of a specific trigger message, e.g., in the SCI (lower layer) or in the LPP/NPPa from the LMF, and/or, for the semi-persistent feedback, a trigger may toggle it off, and/or (c) periodic where the feedback may be (pre-)configured.

Note that in at least some embodiments described herein, synchronization may be critical for timing based positioning techniques such as SL-TdoA and sidelink round trip time (SL-RTT). As such, it may be necessary for all UEs in a positioning set and/or positioning group to have the same synchronization source. Thus, in some instances, a synchronization source UE and/or a positioning reference UE for sidelink positioning may be indicated and/or identified. Not that a synchronization source UE, (e.g., a SyncRef UE) and a positioning reference UE, (e.g., a PosRef UE) may be bundled or independent. For example, the synchronization source UE and the positioning reference UE may be partially bundled or fully bundled. For partial bundling, a positioning reference UE may always be a synchronization source UE but a synchronization source UE may not always be a positioning reference UE. Note that, by configuration, all UEs in a positioning set should have the same synchronization source UE. However, if UEs has different synchronization source UE and need to perform sidelink positioning, the UEs may need to switch to a common synchronization source UE, e.g., via signaling to indicate the need to switch as well as signaling to determine a common synchronization source UE.

As noted above, for timing based sidelink positioning techniques such as TdoA, accurate positioning measurements requires synchronization among UEs. Thus, in some instances, to improve synchronization, transmission of a sidelink RS may be tied to (e.g., associated with and/or in accordance with) transmission of a sidelink synchronization signal block (S-SSB). For example, the sidelink RS may be transmitted in the same slot as the S-SSB or in a slot immediately after transmission of the S-SSB. In some instances, a dedicated slot may be used for sidelink RS (e.g., such a slot may include up to 12 sidelink RS transmissions and could be wideband). The dedicated slot may be transmitted immediately after the S-SSB slot or within a specified time period of the S-SSB slot. In some instances, a mixed slot of PSSCH and sidelink RS may be used. The mixed slot may be transmitted immediately after the S-SSB slot or within a specified time period of the S-SSB slot. In some instances, the sidelink RS may be incorporated into the S-SSB (e.g., the S-SSB may be enhanced to include one or more sidelink RSs).

In some instances, sensing and resource allocation for PSSCH and a sidelink RS may be bundled. Thus, the sidelink RS may use the same sensing and resource allocation as the PSSCH. In some instances, sensing for PSSCH and sidelink RS may be bundled, however, the resource allocations may not be bundled. In some instances, the sensing and resource allocation for PSSCH may be independent of the sensing and resource allocation for the sidelink RS. For example, in sidelink Mode 1, a base station may assign a different resource for the sidelink RS as compared to the PSSCH. As another example, in sidelink Mode 2, a sidelink RS may have a different resource allocation and different sensing as compared to the PSSCH. In some instances, there may be a dedicated sidelink RS slot for positioning.

In some instances, a stage 1 SCI for PSSCH may be used for resource reservation of a current transmission of a transmission block as well as up to two retransmissions for the PSSCH. Thus, at least a portion of this resource reservation may be used for sidelink RS. For example, the sidelink RS may only use resources associated with the current transmission. As another example, the sidelink RS may use all resources defined by the stage 1 SCI for PSSCH (e.g., the sidelink RS may use the resource reservation for the current transmission and the two retransmissions). As another example, the sidelink RS may use resources associated with the current transmission as well as resource for the up to two retransmissions (e.g., the sidelink RS may only use additional resources beyond current transmission as necessary). In some instances, a dedicated stage 1 SCI may be used for sidelink RS resource reservations.

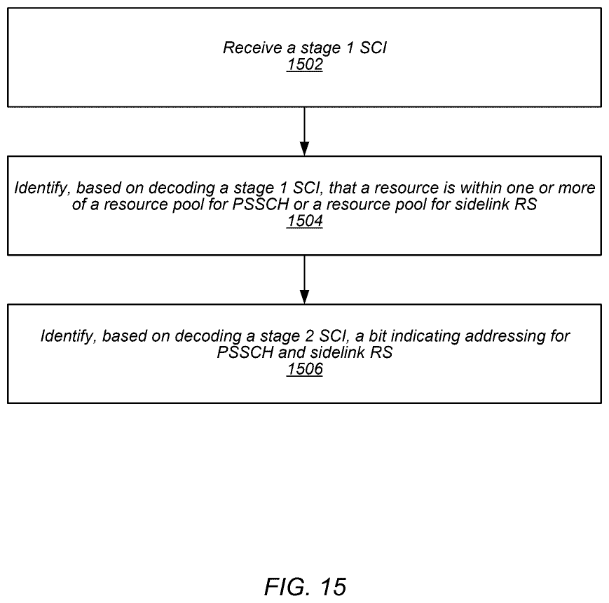

FIG. 15 illustrates a block diagram of an example of a method for signaling physical sidelink shared channel (PSSCH) and sidelink reference signals (RSs), according to some embodiments. The method shown in FIG. 15 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1502, a UE, such as UE 106, may receive a stage 1 sidelink control information (SCI). The stage 1 SCI may include one or more of a priority, a time resource assignment, a frequency resource assignment, a format of the stage 2 SCI, a modulation and coding scheme, and/or a resource reservation period.

At 1504, the UE may identify, based on decoding a stage 1 SCI, that a resource is within one or more of a resource pool for a physical sidelink shared channel (PSSCH) or a resource pool for sidelink reference signal (RS). The sidelink RS may be one of a positioning reference signal (PRS) or sounding reference signal (SRS). The PRS may be a sidelink PRS. The SRS may be a sidelink SRS.

At 1506, the UE may identify, based on decoding a stage 2 SCI, a bit indicating addressing for PSSCH and/or sidelink RS. The stage 2 SCI may be one of an SCI Format 0, SCI Format 1, or SCI Format 2. The stage 2 SCI may include one or more of a hybrid automatic repeat request (HARQ) identifier (ID), a new data indicator, a redundancy version, a source ID, and/or a destination ID.

In some instances, the UE may determine, based on a group identifier in the stage 2 SCI, whether the UE is receiving or not receiving one or more of the PSSCH or sidelink RS. The group identifier may be 16 bits. In some instances, a bit in the stage 2 SCI may indicate separate UE grouping for PSSCH and sidelink RS. In some instances, the group identifier may include a destination identifier associated with the PSSCH and a destination identifier associated with the sidelink RS. In some instances, the group identifier may include a destination identifier associated with both the PSSCH and the sidelink RS. In such instances, one or more bitmaps may indicate destinations for the PSSCH and the sidelink RS. Additionally, a first bitmap may indicate destinations for the PSSCH and a second bitmap may indicate destinations for the sidelink RS. A length of the second bitmap may be based on a number of UEs in a groupcast. Further, the UE may receive an indication of a positional assignment for the first bitmap and the second bitmap. The indication may be received via one of radio resource control (RRC) signaling, a medium access control (MAC) control element (CE), or dynamically via other signaling. In addition, a third bitmap may indicate a set of UEs. In some instances, a bitmap may indicate destinations for the PSSCH and all UEs within group identifier may receive the sidelink RS. In such instances, the UE may receive an indication of a positional assignment for the bitmap. The indication may be received via one of radio resource control (RRC) signaling, a medium access control (MAC) control element (CE), or dynamically via other signaling. Further, a maximum size of the bitmap may be preconfigured. In some instances, a bitmap may indicate destinations for the sidelink RS and all UEs within group identifier may receive the PSSCH. In such instances, the UE may receive an indication of a positional assignment for the bitmap. The indication may be received via one of radio resource control (RRC) signaling, a medium access control (MAC) control element (CE), or dynamically via other signaling. Further, a maximum size of the bitmap may be preconfigured. In some instances, the group identifier may include a first indicator associated with destinations for the PSSCH and a second indicator associated with destinations for the sidelink RS. The first indicator may include a first destination identifier and a first number of UEs receiving the PSSCH. The second indicator may include a second destination identifier and a second number of UEs receiving the sidelink RS. A size of destination identifiers may be 16 bits and a size of destination identifiers may be pre-configured or dynamically assigned. In some instances, the group identifier may include an indicator associated with destinations for the PSSCH and the sidelink RS. The indicator may include a destination identifier and a number of UEs receiving the PSSCH and the sidelink RS. A size of destination identifier may be 16 bits and a size of the destination identifier may be pre-configured or dynamically assigned.

In some instances, the UE may, in response to determining that the UE is receiving the sidelink RS, receive the sidelink RS. The sidelink RS may be unicast, broadcast, or multi-cast to the UE. In some instances, the sidelink RS may be bundled with the PSSCH. In some instances, the SCI may be the same for the PSSCH and the sidelink RS. In some instances, the PSSCH and the sidelink RS may use the same frequency resources or different frequency resources. In some instances, the sidelink RS may not bundled with the PSSCH and the UE may receive a sidelink RS specific stage 1 SCI. In such instances, the sidelink RS may be pre-configured and the stage 2 SCI may be the same for the PSSCH and the sidelink RS. In some instances, the UE may receive a sidelink RS specific stage 2 SCI.

In some instances, in response to determining that the UE is receiving the sidelink RS, the UE may perform positioning reporting. The stage 2 SCI may include a measurement indicator. The measurement indicator may indicate that positioning reporting is required. In some instances, the UE may receive an indication to provide positioning reporting and provide, based on the indication, a positioning report. Alternatively and/or additionally, the positioning reporting may be preconfigured and the UE may periodically provide a positioning report based on the pre-configuration. In some instances, the UE may provide, to a location management function, such as LMF 609, a positioning report and the positioning report may be obtained via a location positioning protocol procedure. A type of measurement to perform with regards to the positioning reporting may be preconfigured. The type of measurement may include one or more of sidelink time difference of arrival (SL-TDOA) measurements, sidelink sounding reference signal (SL-SRS) measurements, sidelink positioning reference signal (SL-PRS) measurements, and/or sidelink reference signal received power (SL-RSRP) measurements. In some instances, the UE may receive, from another UE, the type of measurement via the PSSCH. A medium access control (MAC) control element (CE) may indicate the type of measurement. In some instances, the UE may receive, from a base station, the type of measurement via a physical uplink control channel (PUCCH) or physical uplink shared channel (PUSCH). In some instances, the UE may receive, from a location management function, such as LMF 609, the type of measurement via a location positioning protocol. The LMF may be one of a local LMF or a network LMF.

In some instances, the UE may determine a synchronization reference UE for performance of sidelink positioning measurements and determine a positioning reference UE for performance of the sidelink positioning measurements. The positioning reference UE may always be the synchronization reference UE and the synchronization UE may not always be the positioning reference UE. In some instances, the positioning reference UE and the synchronization reference UE may be the same UE or the positioning reference UE and the synchronization reference UE may be different UEs. In some instances, the UE may determine that the synchronization reference UE for the UE is different than one or more synchronization reference UEs for one or more UEs participating in the sidelink positioning measurements. In addition, the UE may coordinate with the one or more UEs participating in the sidelink positioning measurements to determine a common synchronization reference UE for the UE and the one or more UEs and perform at least one of synchronizing with the common synchronization reference UE when the common synchronization UE is not the synchronization reference UE or maintaining synchronization with the synchronization reference UE when the common synchronization reference UE is the synchronization reference UE. In some instances, transmission of the sidelink RS may be coordinated with transmission of a sidelink synchronization signal block (S-SSB). The S-SSB may be transmitted in a first slot and the sidelink RS is transmitted in a second slot after the first slot. The second slot may occur immediately after the first slot or within a specified time period of the first slot. The second slot may be dedicated for the sidelink RS or may be a mixed slot of the sidelink RS and the PSSCH. In some instances, the sidelink RS and the S-SSB may be transmitted in the same slot. In such instances, the S-SSB may include the sidelink RS.

In some instances, the UE may determine a resource allocation for one or more of the PSSCH or sidelink RS and sense resources for one or more of the PSSCH or sidelink RS. In some instances, the PSSCH and the sidelink RS may use a common resource allocation or may have different resource allocations. In some instances, to determine the resource allocation for one or more of the PSSCH or sidelink RS, the UE may receive, from a base station, a first resource allocation for the PSSCH and a second resource allocation for the sidelink RS. The first resource allocation may be different than the second resource allocation. In some instances, to determine the resource allocation for one or more of the PSSCH or sidelink RS, the UE may determine the resource allocation for the sidelink RS based, at least in part, on PSSCH resources indicated in the stage 1 SCI. The PSSCH resources indicated in the stage 1 SCI may include a reservation for a current transport block and no more than two retransmissions for the PSSCH. In such instances, the resource allocation for the sidelink RS may be the current transport block, the resource allocation for the sidelink RS may be the PSSCH resources indicated in the state 1 SCI, or the resource allocation for the sidelink RS may be the current transport block and resources for up to two retransmissions, if needed. In some instances, to determine the resource allocation for one or more of the PSSCH or sidelink RS, the UE may determine the resource allocation for the sidelink RS based on sidelink RS resources includes in a stage 1 SCI dedicated to the sidelink RS.

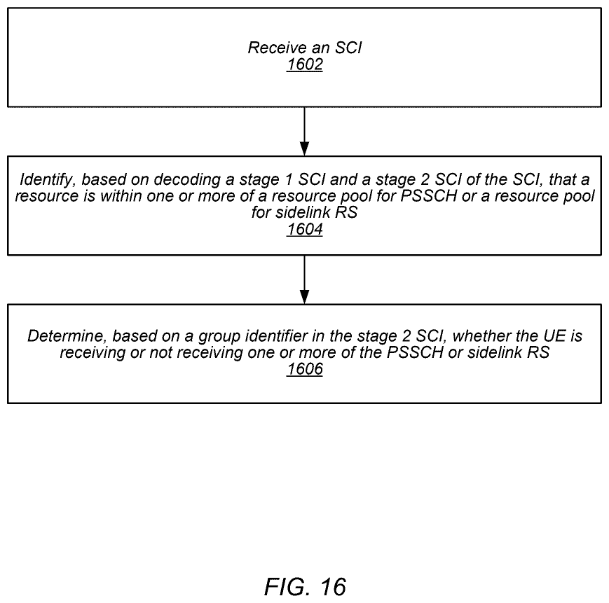

FIG. 16 illustrates a block diagram of another example of a method for signaling physical sidelink shared channel (PSSCH) and sidelink reference signals (RSS), according to some embodiments. The method shown in FIG. 16 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1602, a UE, such as UE 106, may receive a sidelink control information (SCI). The SCI may include a stage 1 SCI and/or a stage 2 SCI. The stage 1 SCI may include one or more of a priority, a time resource assignment, a frequency resource assignment, a format of the stage 2 SCI, a modulation and coding scheme, and/or a resource reservation period.

At 1604, the UE may identify, based on decoding a stage 1 SCI and a stage 2 SCI of the SCI, that a resource is within one or more of a resource pool for a physical sidelink shared channel (PSSCH) or a resource pool for sidelink reference signal (RS). The sidelink RS may be one of a positioning reference signal (PRS) or sounding reference signal (SRS). The PRS may be a sidelink PRS. The SRS may be a sidelink SRS. In some instances, the UE may identify, based on decoding the stage 2 SCI, a bit indicating addressing for PSSCH and sidelink RS. The stage 2 SCI may be one of an SCI Format 0, SCI Format 1, or SCI Format 2. The stage 2 SCI may include one or more of a hybrid automatic repeat request (HARQ) identifier (ID), a new data indicator, a redundancy version, a source ID, and/or a destination ID.

At 1606, the UE may determine, based on a group identifier in the stage 2 SCI, whether the UE is receiving or not receiving one or more of the PSSCH or sidelink RS. The group identifier may be 16 bits. In some instances, a bit in the stage 2 SCI may indicate separate UE grouping for PSSCH and sidelink RS. In some instances, the group identifier may include a destination identifier associated with the PSSCH and a destination identifier associated with the sidelink RS. In some instances, the group identifier may include a destination identifier associated with both the PSSCH and the sidelink RS. In such instances, one or more bitmaps may indicate destinations for the PSSCH and the sidelink RS. Additionally, a first bitmap may indicate destinations for the PSSCH and a second bitmap may indicate destinations for the sidelink RS. A length of the second bitmap may be based on a number of UEs in a groupcast. Further, the UE may receive an indication of a positional assignment for the first bitmap and the second bitmap. The indication may be received via one of radio resource control (RRC) signaling, a medium access control (MAC) control element (CE), or dynamically via other signaling. In addition, a third bitmap may indicate a set of UEs. In some instances, a bitmap may indicate destinations for the PSSCH and all UEs within group identifier may receive the sidelink RS. In such instances, the UE may receive an indication of a positional assignment for the bitmap. The indication may be received via one of radio resource control (RRC) signaling, a medium access control (MAC) control element (CE), or dynamically via other signaling. Further, a maximum size of the bitmap may be preconfigured. In some instances, a bitmap may indicate destinations for the sidelink RS and all UEs within group identifier may receive the PSSCH. In such instances, the UE may receive an indication of a positional assignment for the bitmap. The indication may be received via one of radio resource control (RRC) signaling, a medium access control (MAC) control element (CE), or dynamically via other signaling. Further, a maximum size of the bitmap may be preconfigured. In some instances, the group identifier may include a first indicator associated with destinations for the PSSCH and a second indicator associated with destinations for the sidelink RS. The first indicator may include a first destination identifier and a first number of UEs receiving the PSSCH. The second indicator may include a second destination identifier and a second number of UEs receiving the sidelink RS. A size of destination identifiers may be 16 bits and a size of destination identifiers may be pre-configured or dynamically assigned. In some instances, the group identifier may include an indicator associated with destinations for the PSSCH and the sidelink RS. The indicator may include a destination identifier and a number of UEs receiving the PSSCH and the sidelink RS. A size of destination identifier may be 16 bits and a size of the destination identifier may be pre-configured or dynamically assigned.

In some instances, the UE may, in response to determining that the UE is receiving the sidelink RS, receive the sidelink RS. The sidelink RS may be unicast, broadcast, or multi-cast to the UE. In some instances, the sidelink RS may be bundled with the PSSCH. In some instances, the SCI may be the same for the PSSCH and the sidelink RS. In some instances, the PSSCH and the sidelink RS may use the same frequency resources or different frequency resources. In some instances, the sidelink RS may not bundled with the PSSCH and the UE may receive a sidelink RS specific stage 1 SCI. In such instances, the sidelink RS may be pre-configured and the stage 2 SCI may be the same for the PSSCH and the sidelink RS. In some instances, the UE may receive a sidelink RS specific stage 2 SCI.

In some instances, in response to determining that the UE is receiving the sidelink RS, the UE may perform positioning reporting. The stage 2 SCI may include a measurement indicator. The measurement indicator may indicate that positioning reporting is required. In some instances, the UE may receive an indication to provide positioning reporting and provide, based on the indication, a positioning report. The positioning reporting may be preconfigured and the UE may periodically provide a positioning report based on the pre-configuration. In some instances, the UE may provide, to a location management function, such as LMF 609, a positioning report and the positioning report may be obtained via a location positioning protocol procedure. A type of measurement to perform with regards to the positioning reporting may be preconfigured. The type of measurement may include one or more of sidelink time difference of arrival (SL-TDOA) measurements, sidelink sounding reference signal (SL-SRS) measurements, sidelink positioning reference signal (SL-PRS) measurements, and/or sidelink reference signal received power (SL-RSRP) measurements. In some instances, the UE may receive, from another UE, the type of measurement via the PSSCH. A medium access control (MAC) control element (CE) may indicate the type of measurement. In some instances, the UE may receive, from a base station, the type of measurement via a physical uplink control channel (PUCCH) or physical uplink shared channel (PUSCH). In some instances, the UE may receive, from a location management function, such as LMF 609, the type of measurement via a location positioning protocol. The LMF may be one of a local LMF or a network LMF.

In some instances, the UE may determine a synchronization reference UE for performance of sidelink positioning measurements and determine a positioning reference UE for performance of the sidelink positioning measurements. The positioning reference UE may always be the synchronization reference UE and the synchronization UE may not always be the positioning reference UE. In some instances, the positioning reference UE and the synchronization reference UE may be the same UE or the positioning reference UE and the synchronization reference UE may be different UEs. In some instances, the UE may determine that the synchronization reference UE for the UE is different than one or more synchronization reference UEs for one or more UEs participating in the sidelink positioning measurements. In addition, the UE may coordinate with the one or more UEs participating in the sidelink positioning measurements to determine a common synchronization reference UE for the UE and the one or more UEs and perform at least one of synchronizing with the common synchronization reference UE when the common synchronization UE is not the synchronization reference UE or maintaining synchronization with the synchronization reference UE when the common synchronization reference UE is the synchronization reference UE. In some instances, transmission of the sidelink RS may be coordinated with transmission of a sidelink synchronization signal block (S-SSB). The S-SSB may be transmitted in a first slot and the sidelink RS is transmitted in a second slot after the first slot. The second slot may occur immediately after the first slot or within a specified time period of the first slot. The second slot may be dedicated for the sidelink RS or may be a mixed slot of the sidelink RS and the PSSCH. In some instances, the sidelink RS and the S-SSB may be transmitted in the same slot. In such instances, the S-SSB may include the sidelink RS.

In some instances, the UE may determine a resource allocation for one or more of the PSSCH or sidelink RS and sense resources for one or more of the PSSCH or sidelink RS. In some instances, the PSSCH and the sidelink RS may use a common resource allocation or may have different resource allocations. In some instances, to determine the resource allocation for one or more of the PSSCH or sidelink RS, the UE may receive, from a base station, a first resource allocation for the PSSCH and a second resource allocation for the sidelink RS. The first resource allocation may be different than the second resource allocation. In some instances, to determine the resource allocation for one or more of the PSSCH or sidelink RS, the UE may determine the resource allocation for the sidelink RS based, at least in part, on PSSCH resources indicated in the stage 1 SCI. The PSSCH resources indicated in the stage 1 SCI may include a reservation for a current transport block and no more than two retransmissions for the PSSCH. In such instances, the resource allocation for the sidelink RS may be the current transport block, the resource allocation for the sidelink RS may be the PSSCH resources indicated in the state 1 SCI, or the resource allocation for the sidelink RS may be the current transport block and resources for up to two retransmissions, if needed. In some instances, to determine the resource allocation for one or more of the PSSCH or sidelink RS, the UE may determine the resource allocation for the sidelink RS based on sidelink RS resources includes in a stage 1 SCI dedicated to the sidelink RS.

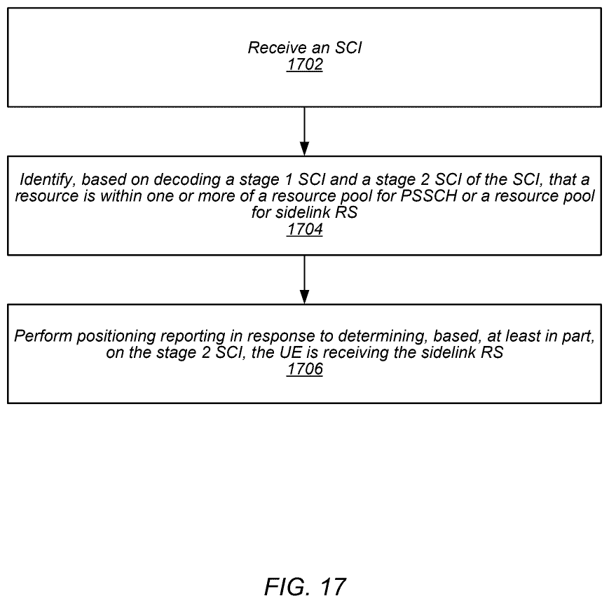

FIG. 17 illustrates a block diagram of an example of a method for positioning reporting, according to some embodiments. The method shown in FIG. 17 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1702, a UE, such as UE 106, may receive a sidelink control information (SCI). The SCI may include a stage 1 SCI and/or a stage 2 SCI. The stage 1 SCI may include one or more of a priority, a time resource assignment, a frequency resource assignment, a format of the stage 2 SCI, a modulation and coding scheme, and/or a resource reservation period.

At 1704, the UE may identify, based on decoding a stage 1 SCI and a stage 2 SCI of the SCI, that a resource is within one or more of a resource pool for a physical sidelink shared channel (PSSCH) or a resource pool for sidelink reference signal (RS). The sidelink RS may be one of a positioning reference signal (PRS) or sounding reference signal (SRS). The PRS may be a sidelink PRS. The SRS may be a sidelink SRS. In some instances, the UE may identify, based on decoding the stage 2 SCI, a bit indicating addressing for PSSCH and sidelink RS. The stage 2 SCI may be one of an SCI Format 0, SCI Format 1, or SCI Format 2. The stage 2 SCI may include one or more of a hybrid automatic repeat request (HARQ) identifier (ID), a new data indicator, a redundancy version, a source ID, and/or a destination ID.

At 1706, the UE may, in response to determining, based at least in part, on the stage 2 SCI, the UE is receiving the sidelink RS, perform positioning reporting. In some instances, the stage 2 SCI may include a measurement indicator. The measurement indicator may indicate that positioning reporting is required. In some instances, the UE may receive an indication to provide positioning reporting and provide, based on the indication, a positioning report. The positioning reporting may be preconfigured and the UE may periodically provide a positioning report based on the pre-configuration. In some instances, the UE may provide, to a location management function, such as LMF 609, a positioning report and the positioning report may be obtained via a location positioning protocol procedure. A type of measurement to perform with regards to the positioning reporting may be preconfigured. The type of measurement may include one or more of sidelink time difference of arrival (SL-TDOA) measurements, sidelink sounding reference signal (SL-SRS) measurements, sidelink positioning reference signal (SL-PRS) measurements, and/or sidelink reference signal received power (SL-RSRP) measurements. In some instances, the UE may receive, from another UE, the type of measurement via the PSSCH. A medium access control (MAC) control element (CE) may indicate the type of measurement. In some instances, the UE may receive, from a base station, the type of measurement via a physical uplink control channel (PUCCH) or physical uplink shared channel (PUSCH). In some instances, the UE may receive, from a location management function, such as LMF 609, the type of measurement via a location positioning protocol. The LMF may be one of a local LMF or a network LMF.

In some instances, to determine, based at least in part, on the stage 2 SCI, the UE is receiving the sidelink RS, the UE may determine, based on a group identifier in the stage 2 SCI, whether the UE is receiving or not receiving one or more of the PSSCH or sidelink RS. The group identifier may be 16 bits. In some instances, a bit in the stage 2 SCI may indicate separate UE grouping for PSSCH and sidelink RS. In some instances, the group identifier may include a destination identifier associated with the PSSCH and a destination identifier associated with the sidelink RS. In some instances, the group identifier may include a destination identifier associated with both the PSSCH and the sidelink RS. In such instances, one or more bitmaps may indicate destinations for the PSSCH and the sidelink RS. Additionally, a first bitmap may indicate destinations for the PSSCH and a second bitmap may indicate destinations for the sidelink RS. A length of the second bitmap may be based on a number of UEs in a groupcast. Further, the UE may receive an indication of a positional assignment for the first bitmap and the second bitmap. The indication may be received via one of radio resource control (RRC) signaling, a medium access control (MAC) control element (CE), or dynamically via other signaling. In addition, a third bitmap may indicate a set of UEs. In some instances, a bitmap may indicate destinations for the PSSCH and all UEs within group identifier may receive the sidelink RS. In such instances, the UE may receive an indication of a positional assignment for the bitmap. The indication may be received via one of radio resource control (RRC) signaling, a medium access control (MAC) control element (CE), or dynamically via other signaling. Further, a maximum size of the bitmap may be preconfigured. In some instances, a bitmap may indicate destinations for the sidelink RS and all UEs within group identifier may receive the PSSCH. In such instances, the UE may receive an indication of a positional assignment for the bitmap. The indication may be received via one of radio resource control (RRC) signaling, a medium access control (MAC) control element (CE), or dynamically via other signaling. Further, a maximum size of the bitmap may be preconfigured. In some instances, the group identifier may include a first indicator associated with destinations for the PSSCH and a second indicator associated with destinations for the sidelink RS. The first indicator may include a first destination identifier and a first number of UEs receiving the PSSCH. The second indicator may include a second destination identifier and a second number of UEs receiving the sidelink RS. A size of destination identifiers may be 16 bits and a size of destination identifiers may be pre-configured or dynamically assigned. In some instances, the group identifier may include an indicator associated with destinations for the PSSCH and the sidelink RS. The indicator may include a destination identifier and a number of UEs receiving the PSSCH and the sidelink RS. A size of destination identifier may be 16 bits and a size of the destination identifier may be pre-configured or dynamically assigned.

In some instances, the UE may, in response to determining that the UE is receiving the sidelink RS, receive the sidelink RS. The sidelink RS may be unicast, broadcast, or multi-cast to the UE. In some instances, the sidelink RS may be bundled with the PSSCH. In some instances, the SCI may be the same for the PSSCH and the sidelink RS. In some instances, the PSSCH and the sidelink RS may use the same frequency resources or different frequency resources. In some instances, the sidelink RS may not bundled with the PSSCH and the UE may receive a sidelink RS specific stage 1 SCI. In such instances, the sidelink RS may be pre-configured and the stage 2 SCI may be the same for the PSSCH and the sidelink RS. In some instances, the UE may receive a sidelink RS specific stage 2 SCI.

In some instances, the UE may determine a synchronization reference UE for performance of sidelink positioning measurements and determine a positioning reference UE for performance of the sidelink positioning measurements. The positioning reference UE may always be the synchronization reference UE and the synchronization UE may not always be the positioning reference UE. In some instances, the positioning reference UE and the synchronization reference UE may be the same UE or the positioning reference UE and the synchronization reference UE may be different UEs. In some instances, the UE may determine that the synchronization reference UE for the UE is different than one or more synchronization reference UEs for one or more UEs participating in the sidelink positioning measurements. In addition, the UE may coordinate with the one or more UEs participating in the sidelink positioning measurements to determine a common synchronization reference UE for the UE and the one or more UEs and perform at least one of synchronizing with the common synchronization reference UE when the common synchronization UE is not the synchronization reference UE or maintaining synchronization with the synchronization reference UE when the common synchronization reference UE is the synchronization reference UE. In some instances, transmission of the sidelink RS may be coordinated with transmission of a sidelink synchronization signal block (S-SSB). The S-SSB may be transmitted in a first slot and the sidelink RS is transmitted in a second slot after the first slot. The second slot may occur immediately after the first slot or within a specified time period of the first slot. The second slot may be dedicated for the sidelink RS or may be a mixed slot of the sidelink RS and the PSSCH. In some instances, the sidelink RS and the S-SSB may be transmitted in the same slot. In such instances, the S-SSB may include the sidelink RS.

In some instances, the UE may determine a resource allocation for one or more of the PSSCH or sidelink RS and sense resources for one or more of the PSSCH or sidelink RS. In some instances, the PSSCH and the sidelink RS may use a common resource allocation or may have different resource allocations. In some instances, to determine the resource allocation for one or more of the PSSCH or sidelink RS, the UE may receive, from a base station, a first resource allocation for the PSSCH and a second resource allocation for the sidelink RS. The first resource allocation may be different than the second resource allocation. In some instances, to determine the resource allocation for one or more of the PSSCH or sidelink RS, the UE may determine the resource allocation for the sidelink RS based, at least in part, on PSSCH resources indicated in the stage 1 SCI. The PSSCH resources indicated in the stage 1 SCI may include a reservation for a current transport block and no more than two retransmissions for the PSSCH. In such instances, the resource allocation for the sidelink RS may be the current transport block, the resource allocation for the sidelink RS may be the PSSCH resources indicated in the state 1 SCI, or the resource allocation for the sidelink RS may be the current transport block and resources for up to two retransmissions, if needed. In some instances, to determine the resource allocation for one or more of the PSSCH or sidelink RS, the UE may determine the resource allocation for the sidelink RS based on sidelink RS resources includes in a stage 1 SCI dedicated to the sidelink RS.

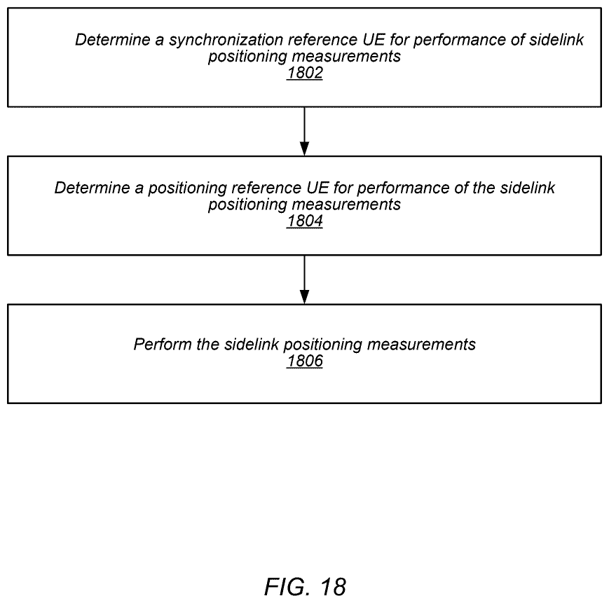

FIG. 18 illustrates a block diagram of an example of a method for performing sidelink positioning measurements, according to some embodiments. The method shown in FIG. 18 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1802, a UE, such as UE 106, may determine a synchronization reference UE for performance of sidelink positioning measurements.

At 1804, the UE may determine a positioning reference UE for performance of the sidelink positioning measurements. The positioning reference UE may always be the synchronization reference UE and the synchronization UE may not always be the positioning reference UE. In some instances, the positioning reference UE and the synchronization reference UE may be the same UE or the positioning reference UE and the synchronization reference UE may be different UEs.

At 1806, the UE may perform sidelink positioning measurements, e.g., while synchronization to the synchronization reference UE and/or while using the positioning reference UE to aid in determining a location of the UE.

In some instances, the UE may determine that the synchronization reference UE for the UE is different than one or more synchronization reference UEs for one or more UEs participating in the sidelink positioning measurements. In addition, the UE may coordinate with the one or more UEs participating in the sidelink positioning measurements to determine a common synchronization reference UE for the UE and the one or more UEs and perform at least one of synchronizing with the common synchronization reference UE when the common synchronization UE is not the synchronization reference UE or maintaining synchronization with the synchronization reference UE when the common synchronization reference UE is the synchronization reference UE.

In some instances, transmission of a sidelink RS may be coordinated with transmission of a sidelink synchronization signal block (S-SSB). The S-SSB may be transmitted in a first slot and the sidelink RS is transmitted in a second slot after the first slot. The second slot may occur immediately after the first slot or within a specified time period of the first slot. The second slot may be dedicated for the sidelink RS or may be a mixed slot of the sidelink RS and the PSSCH. In some instances, the sidelink RS and the S-SSB may be transmitted in the same slot. In such instances, the S-SSB may include the sidelink RS.

In some instances, the UE may receive a stage 1 sidelink control information (SCI). The stage 1 SCI may include one or more of a priority, a time resource assignment, a frequency resource assignment, a format of the stage 2 SCI, a modulation and coding scheme, and/or a resource reservation period. In addition, the UE may identify, based on decoding a stage 1 SCI, that a resource is within one or more of a resource pool for a physical sidelink shared channel (PSSCH) or a resource pool for sidelink reference signal (RS). The sidelink RS may be one of a positioning reference signal (PRS) or sounding reference signal (SRS). The PRS may be a sidelink PRS. The SRS may be a sidelink SRS. Further, the UE may identify, based on decoding a stage 2 SCI, a bit indicating addressing for PSSCH and sidelink RS. The stage 2 SCI may be one of an SCI Format 0, SCI Format 1, or SCI Format 2. The stage 2 SCI may include one or more of a hybrid automatic repeat request (HARQ) identifier (ID), a new data indicator, a redundancy version, a source ID, and/or a destination ID.

In some instances, the UE may determine, based on a group identifier in the stage 2 SCI, whether the UE is receiving or not receiving one or more of the PSSCH or sidelink RS. The group identifier may be 16 bits. In some instances, a bit in the stage 2 SCI may indicate separate UE grouping for PSSCH and sidelink RS. In some instances, the group identifier may include a destination identifier associated with the PSSCH and a destination identifier associated with the sidelink RS. In some instances, the group identifier may include a destination identifier associated with both the PSSCH and the sidelink RS. In such instances, one or more bitmaps may indicate destinations for the PSSCH and the sidelink RS. Additionally, a first bitmap may indicate destinations for the PSSCH and a second bitmap may indicate destinations for the sidelink RS. A length of the second bitmap may be based on a number of UEs in a groupcast. Further, the UE may receive an indication of a positional assignment for the first bitmap and the second bitmap. The indication may be received via one of radio resource control (RRC) signaling, a medium access control (MAC) control element (CE), or dynamically via other signaling. In addition, a third bitmap may indicate a set of UEs. In some instances, a bitmap may indicate destinations for the PSSCH and all UEs within group identifier may receive the sidelink RS. In such instances, the UE may receive an indication of a positional assignment for the bitmap. The indication may be received via one of radio resource control (RRC) signaling, a medium access control (MAC) control element (CE), or dynamically via other signaling. Further, a maximum size of the bitmap may be preconfigured. In some instances, a bitmap may indicate destinations for the sidelink RS and all UEs within group identifier may receive the PSSCH. In such instances, the UE may receive an indication of a positional assignment for the bitmap. The indication may be received via one of radio resource control (RRC) signaling, a medium access control (MAC) control element (CE), or dynamically via other signaling. Further, a maximum size of the bitmap may be preconfigured. In some instances, the group identifier may include a first indicator associated with destinations for the PSSCH and a second indicator associated with destinations for the sidelink RS. The first indicator may include a first destination identifier and a first number of UEs receiving the PSSCH. The second indicator may include a second destination identifier and a second number of UEs receiving the sidelink RS. A size of destination identifiers may be 16 bits and a size of destination identifiers may be pre-configured or dynamically assigned. In some instances, the group identifier may include an indicator associated with destinations for the PSSCH and the sidelink RS. The indicator may include a destination identifier and a number of UEs receiving the PSSCH and the sidelink RS. A size of destination identifier may be 16 bits and a size of the destination identifier may be pre-configured or dynamically assigned.

In some instances, the UE may, in response to determining that the UE is receiving the sidelink RS, receive the sidelink RS. The sidelink RS may be unicast, broadcast, or multi-cast to the UE. In some instances, the sidelink RS may be bundled with the PSSCH. In some instances, the SCI may be the same for the PSSCH and the sidelink RS. In some instances, the PSSCH and the sidelink RS may use the same frequency resources or different frequency resources. In some instances, the sidelink RS may not bundled with the PSSCH and the UE may receive a sidelink RS specific stage 1 SCI. In such instances, the sidelink RS may be pre-configured and the stage 2 SCI may be the same for the PSSCH and the sidelink RS. In some instances, the UE may receive a sidelink RS specific stage 2 SCI.

In some instances, in response to determining that the UE is receiving the sidelink RS, the UE may perform positioning reporting. The stage 2 SCI may include a measurement indicator. The measurement indicator may indicate that positioning reporting is required. In some instances, the UE may receive an indication to provide positioning reporting and provide, based on the indication, a positioning report. The positioning reporting may be preconfigured and the UE may periodically provide a positioning report based on the pre-configuration. In some instances, the UE may provide, to a location management function, such as LMF 609, a positioning report and the positioning report may be obtained via a location positioning protocol procedure. A type of measurement to perform with regards to the positioning reporting may be preconfigured. The type of measurement may include one or more of sidelink time difference of arrival (SL-TDOA) measurements, sidelink sounding reference signal (SL-SRS) measurements, sidelink positioning reference signal (SL-PRS) measurements, and/or sidelink reference signal received power (SL-RSRP) measurements. In some instances, the UE may receive, from another UE, the type of measurement via the PSSCH. A medium access control (MAC) control element (CE) may indicate the type of measurement. In some instances, the UE may receive, from a base station, the type of measurement via a physical uplink control channel (PUCCH) or physical uplink shared channel (PUSCH). In some instances, the UE may receive, from a location management function, such as LMF 609, the type of measurement via a location positioning protocol. The LMF may be one of a local LMF or a network LMF.

In some instances, the UE may determine a resource allocation for one or more of the PSSCH or sidelink RS and sense resources for one or more of the PSSCH or sidelink RS. In some instances, the PSSCH and the sidelink RS may use a common resource allocation or may have different resource allocations. In some instances, to determine the resource allocation for one or more of the PSSCH or sidelink RS, the UE may receive, from a base station, a first resource allocation for the PSSCH and a second resource allocation for the sidelink RS. The first resource allocation may be different than the second resource allocation. In some instances, to determine the resource allocation for one or more of the PSSCH or sidelink RS, the UE may determine the resource allocation for the sidelink RS based, at least in part, on PSSCH resources indicated in the stage 1 SCI. The PSSCH resources indicated in the stage 1 SCI may include a reservation for a current transport block and no more than two retransmissions for the PSSCH. In such instances, the resource allocation for the sidelink RS may be the current transport block, the resource allocation for the sidelink RS may be the PSSCH resources indicated in the state 1 SCI, or the resource allocation for the sidelink RS may be the current transport block and resources for up to two retransmissions, if needed. In some instances, to determine the resource allocation for one or more of the PSSCH or sidelink RS, the UE may determine the resource allocation for the sidelink RS based on sidelink RS resources includes in a stage 1 SCI dedicated to the sidelink RS.

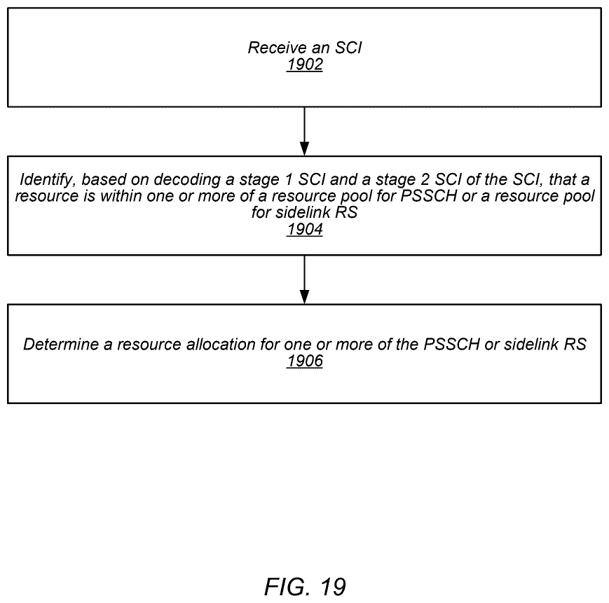

FIG. 19 illustrates a block diagram of another example of a method for determining resource allocation for a physical sidelink shared channel (PSSCH) and/or a sidelink reference signals (RSS), according to some embodiments. The method shown in FIG. 19 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1902, a UE, such as UE 106, may receive a sidelink control information (SCI). The SCI may include a stage 1 SCI and/or a stage 2 SCI. The stage 1 SCI may include one or more of a priority, a time resource assignment, a frequency resource assignment, a format of the stage 2 SCI, a modulation and coding scheme, and/or a resource reservation period.

At 1904, the UE may identify, based on decoding a stage 1 SCI and a stage 2 SCI of the SCI, that a resource is within one or more of a resource pool for a physical sidelink shared channel (PSSCH) or a resource pool for sidelink reference signal (RS). The sidelink RS may be one of a positioning reference signal (PRS) or sounding reference signal (SRS). The PRS may be a sidelink PRS. The SRS may be a sidelink SRS. In some instances, the UE may identify, based on decoding the stage 2 SCI, a bit indicating addressing for PSSCH and sidelink RS. The stage 2 SCI may be one of an SCI Format 0, SCI Format 1, or SCI Format 2. The stage 2 SCI may include one or more of a hybrid automatic repeat request (HARQ) identifier (ID), a new data indicator, a redundancy version, a source ID, and/or a destination ID.

At 1906, the UE may determine a resource allocation for one or more of the PSSCH or sidelink RS. In some instances, the UE may sense resources for one or more of the PSSCH or sidelink RS. In some instances, the PSSCH and the sidelink RS may use a common resource allocation or may have different resource allocations.

In some instances, to determine the resource allocation for one or more of the PSSCH or sidelink RS, the UE may receive, from a base station, a first resource allocation for the PSSCH and a second resource allocation for the sidelink RS. The first resource allocation may be different than the second resource allocation.

In some instances, to determine the resource allocation for one or more of the PSSCH or sidelink RS, the UE may determine the resource allocation for the sidelink RS based, at least in part, on PSSCH resources indicated in the stage 1 SCI. The PSSCH resources indicated in the stage 1 SCI may include a reservation for a current transport block and no more than two retransmissions for the PSSCH. In such instances, the resource allocation for the sidelink RS may be the current transport block, the resource allocation for the sidelink RS may be the PSSCH resources indicated in the state 1 SCI, or the resource allocation for the sidelink RS may be the current transport block and resources for up to two retransmissions, if needed.

In some instances, to determine the resource allocation for one or more of the PSSCH or sidelink RS, the UE may determine the resource allocation for the sidelink RS based on sidelink RS resources includes in a stage 1 SCI dedicated to the sidelink RS.

In some instances, the UE may determine, based on a group identifier in the stage 2 SCI, whether the UE is receiving or not receiving one or more of the PSSCH or sidelink RS. The group identifier may be 16 bits. In some instances, a bit in the stage 2 SCI may indicate separate UE grouping for PSSCH and sidelink RS. In some instances, the group identifier may include a destination identifier associated with the PSSCH and a destination identifier associated with the sidelink RS. In some instances, the group identifier may include a destination identifier associated with both the PSSCH and the sidelink RS. In such instances, one or more bitmaps may indicate destinations for the PSSCH and the sidelink RS. Additionally, a first bitmap may indicate destinations for the PSSCH and a second bitmap may indicate destinations for the sidelink RS. A length of the second bitmap may be based on a number of UEs in a groupcast. Further, the UE may receive an indication of a positional assignment for the first bitmap and the second bitmap. The indication may be received via one of radio resource control (RRC) signaling, a medium access control (MAC) control element (CE), or dynamically via other signaling. In addition, a third bitmap may indicate a set of UEs. In some instances, a bitmap may indicate destinations for the PSSCH and all UEs within group identifier may receive the sidelink RS. In such instances, the UE may receive an indication of a positional assignment for the bitmap. The indication may be received via one of radio resource control (RRC) signaling, a medium access control (MAC) control element (CE), or dynamically via other signaling. Further, a maximum size of the bitmap may be preconfigured. In some instances, a bitmap may indicate destinations for the sidelink RS and all UEs within group identifier may receive the PSSCH. In such instances, the UE may receive an indication of a positional assignment for the bitmap. The indication may be received via one of radio resource control (RRC) signaling, a medium access control (MAC) control element (CE), or dynamically via other signaling. Further, a maximum size of the bitmap may be preconfigured. In some instances, the group identifier may include a first indicator associated with destinations for the PSSCH and a second indicator associated with destinations for the sidelink RS. The first indicator may include a first destination identifier and a first number of UEs receiving the PSSCH. The second indicator may include a second destination identifier and a second number of UEs receiving the sidelink RS. A size of destination identifiers may be 16 bits and a size of destination identifiers may be pre-configured or dynamically assigned. In some instances, the group identifier may include an indicator associated with destinations for the PSSCH and the sidelink RS. The indicator may include a destination identifier and a number of UEs receiving the PSSCH and the sidelink RS. A size of destination identifier may be 16 bits and a size of the destination identifier may be pre-configured or dynamically assigned.

In some instances, the UE may, in response to determining that the UE is receiving the sidelink RS, receive the sidelink RS. The sidelink RS may be unicast, broadcast, or multi-cast to the UE. In some instances, the sidelink RS may be bundled with the PSSCH. In some instances, the SCI may be the same for the PSSCH and the sidelink RS. In some instances, the PSSCH and the sidelink RS may use the same frequency resources or different frequency resources. In some instances, the sidelink RS may not bundled with the PSSCH and the UE may receive a sidelink RS specific stage 1 SCI. In such instances, the sidelink RS may be pre-configured and the stage 2 SCI may be the same for the PSSCH and the sidelink RS. In some instances, the UE may receive a sidelink RS specific stage 2 SCI.

In some instances, in response to determining that the UE is receiving the sidelink RS, the UE may perform positioning reporting. The stage 2 SCI may include a measurement indicator. The measurement indicator may indicate that positioning reporting is required. In some instances, the UE may receive an indication to provide positioning reporting and provide, based on the indication, a positioning report. The positioning reporting may be preconfigured and the UE may periodically provide a positioning report based on the pre-configuration. In some instances, the UE may provide, to a location management function, such as LMF 609, a positioning report and the positioning report may be obtained via a location positioning protocol procedure. A type of measurement to perform with regards to the positioning reporting may be preconfigured. The type of measurement may include one or more of sidelink time difference of arrival (SL-TDOA) measurements, sidelink sounding reference signal (SL-SRS) measurements, sidelink positioning reference signal (SL-PRS) measurements, and/or sidelink reference signal received power (SL-RSRP) measurements. In some instances, the UE may receive, from another UE, the type of measurement via the PSSCH. A medium access control (MAC) control element (CE) may indicate the type of measurement. In some instances, the UE may receive, from a base station, the type of measurement via a physical uplink control channel (PUCCH) or physical uplink shared channel (PUSCH). In some instances, the UE may receive, from a location management function, such as LMF 609, the type of measurement via a location positioning protocol. The LMF may be one of a local LMF or a network LMF.

In some instances, the UE may determine a synchronization reference UE for performance of sidelink positioning measurements and determine a positioning reference UE for performance of the sidelink positioning measurements. The positioning reference UE may always be the synchronization reference UE and the synchronization UE may not always be the positioning reference UE. In some instances, the positioning reference UE and the synchronization reference UE may be the same UE or the positioning reference UE and the synchronization reference UE may be different UEs. In some instances, the UE may determine that the synchronization reference UE for the UE is different than one or more synchronization reference UEs for one or more UEs participating in the sidelink positioning measurements. In addition, the UE may coordinate with the one or more UEs participating in the sidelink positioning measurements to determine a common synchronization reference UE for the UE and the one or more UEs and perform at least one of synchronizing with the common synchronization reference UE when the common synchronization UE is not the synchronization reference UE or maintaining synchronization with the synchronization reference UE when the common synchronization reference UE is the synchronization reference UE. In some instances, transmission of the sidelink RS may be coordinated with transmission of a sidelink synchronization signal block (S-SSB). The S-SSB may be transmitted in a first slot and the sidelink RS is transmitted in a second slot after the first slot. The second slot may occur immediately after the first slot or within a specified time period of the first slot. The second slot may be dedicated for the sidelink RS or may be a mixed slot of the sidelink RS and the PSSCH. In some instances, the sidelink RS and the S-SSB may be transmitted in the same slot. In such instances, the S-SSB may include the sidelink RS.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for performing sidelink positioning measurements, comprising:
a user equipment device (UE),
determining a synchronization reference UE for performance of sidelink positioning measurements; and
determining a positioning reference UE for performance of the sidelink positioning measurements.

2. The method of claim 1,
wherein the positioning reference UE is always the synchronization reference UE.

3. The method of claim 2,
wherein the synchronization UE is not always the positioning reference UE.

4. The method of claim 1,
wherein the positioning reference UE and the synchronization reference UE are the same UE.

5. The method of claim 1,
wherein the positioning reference UE and the synchronization reference UE are different UEs.

6. The method of claim 1, further comprising:
the UE,
determining that the synchronization reference UE for the UE is different than one or more synchronization reference UEs for one or more UEs participating in the sidelink positioning measurements.

7. The method of claim 6, further comprising:
the UE,
coordinating with the one or more UEs participating in the sidelink positioning measurements to determine a common synchronization reference UE for the UE and the one or more UEs; and
performing one of:
synchronizing with the common synchronization reference UE when the common synchronization UE is not the synchronization reference UE; or
maintaining synchronization with the synchronization reference UE when the common synchronization reference UE is the synchronization reference UE.

8. The method of claim 1, further comprising:
the UE,
transmitting a sidelink reference signal, wherein transmission of the sidelink RS is coordinated with transmission of a sidelink synchronization signal block (S-SSB).

9. The method of claim 8,
wherein the S-SSB is transmitted in a first slot, and wherein the sidelink RS is transmitted in a second slot after the first slot.

10. The method of claim 9,
wherein the second slot occurs immediately after the first slot.

11. The method of claim 9,
wherein the second slot occurs within a specified time period of the first slot.

12. The method of claim 9,
wherein the second slot is dedicated for the sidelink RS.

13. The method of claim 9,
wherein the second slot is a mixed slot of the sidelink RS and the PSSCH.

14. The method of claim 8,
wherein the sidelink RS and the S-SSB are transmitted in the same slot.

15. The method of claim 14,
wherein the S-SSB includes the sidelink RS.

16.-18. (canceled)

19. A baseband processor, comprising:
a memory; and
processing circuitry in communication with the memory and configured to cause a user equipment device (UE) to:
determine a synchronization reference UE for performance of sidelink positioning measurements; and
determine a positioning reference UE for performance of the sidelink positioning measurements.

20. The baseband processor of claim 19,
wherein the positioning reference UE is always the synchronization reference UE.

21. The baseband processor of claim 20,
wherein the synchronization UE is not always the positioning reference UE.

22. A non-transitory computer readable memory medium storing instructions executable by processing circuitry to cause a user equipment device (UE) to:
determine a synchronization reference UE for performance of sidelink positioning measurements; and
determine a positioning reference UE for performance of the sidelink positioning measurements.

23. The non-transitory computer readable memory medium of claim 22,
wherein the positioning reference UE and the synchronization reference UE are the same UE.
